(19) United States
(12) Patent Application Publication
(10) Pub. No.: US 2023/0297401 A1
(43) Pub. Date: Sep. 21, 2023

(54) HYBRID QUANTUM-CLASSICAL CLOUD PLATFORM AND TASK EXECUTION METHOD

(71) Applicant: INSPUR SUZHOU INTELLIGENT TECHNOLOGY CO., LTD., Suzhou, Jiangsu (CN)

(72) Inventors: Hongzhen LI, Jinan, Shandong (CN); Xin ZHANG, Jinan, Shandong (CN); Yaqian ZHAO, Jinan, Shandong (CN); Rengang LI, Jinan, Shandong (CN)

(21) Appl. No.: 18/020,616

(22) PCT Filed: Sep. 28, 2021
(86) PCT No.: PCT/CN2021/121221

§ 371 Date: Feb. 9, 2023

(30) Foreign Application Priority Data
Nov. 19, 2020 (CN) 202011301939.3

(51) Int. Cl. G06F 9/455; G06N 10/60; G06N 10/80

(52) U.S. Cl. CPC G06F 9/45533; G06N 10/60; G06N 10/80

(57) ABSTRACT

A hybrid quantum-classical cloud platform and a task execution method. The cloud platform comprises: an SaaS layer for providing a user interface so as to acquire, by means of the user interface, a hybrid quantum-classical programming language corresponding to a task to be executed; a PaaS layer for performing algorithm compilation and task separation on the hybrid quantum-classical programming language to obtain a quantum computing task and a classical computing task corresponding to the task to be executed, and respectively allocating resources to the quantum computing task and the classical computing task; and an IaaS layer for executing the quantum computing task using a quantum virtual machine and executing the classical computing task using a classical server according to the resource allocation condition of the PaaS layer. Therefore, the communication overhead and the data delay can be reduced, the task processing efficiency is improved, and the quantum computing advantage is exerted.

### CROSS-REFERENCE TO RELATED APPLICATION

The present disclosure claims priority to the Chinese patent application No.202011301939.3, entitled “HYBRID QUANTUM-CLASSICAL CLOUD PLATFORM AND TASK EXECUTION METHOD”, filed on Nov. 19, 2020 to the CNIPA, China National Intellectual Property Administration, the entire contents of which are incorporated herein by reference.

### TECHNICAL FIELD

The present disclosure relates to the technical field of cloud computing, and in particular to a hybrid quantum-classical cloud platform and a task execution method.

### BACKGROUND

With the development of new-generation information technologies such as artificial intelligence, big data and Internet of things, the current society has advanced into the era of Internet of everything, and data is becoming the largest resource in the information field. However, the explosive increase of data volume puts forward a huge challenge to the computing capacity of a traditional computing system, and how to quickly and effectively process mass data is a main obstacle which limits further application of technologies such as machine learning, big data, quantum chemistry and new drug research and development in recent years. There are two main problems: (1) as Moore's Law is about to reach its limit, the computing capacity of an electronic chip cannot be improved through the improvement process; and (2) the limitation of a memory wall is more and more serious at present, which causes great constraining to the electronic chip.

Quantum computing is one of the most desirable ways to solve the above problems. A quantum cloud platform will become a main form of quantum computing for a long term in the future. At present, the quantum computing cloud platform mainly provides online quantum chips or simulation services. However, in the current quantum computing cloud platform, the classical computing needs to be done in a local device or in other settings, and then frequent communication with the quantum computing cloud platform is carried out to complete the whole computing. Due to a fact that frequent communication between classical computing clusters and quantum computing clusters needs to be carried out, cross-cluster communication causes a large amount of communication overhead. Therefore, data delay between quantum chips and classical equipment is too large, and even original advantages of the quantum computing are lost.

### SUMMARY

In view of this, an objective of the present disclosure is to provide a hybrid quantum-classical cloud platform and a task execution method.

In a first aspect, the present disclosure provides a hybrid quantum-classical cloud platform, including:
a software-as-a-service (SaaS) layer, configured to provide a user interface for acquiring a hybrid quantum-classical programming language corresponding to a to-be-executed task;
a platform as a service (PaaS) layer, configured to obtain a quantum computing task and a classical computing task corresponding to the to-be-executed task by executing algorithm compilation and task separation on the hybrid quantum-classical programming language, and allocate resources to the quantum computing task and the classical computing task respectively; and
an infrastructure as a service (IaaS) layer, configured to, according to a resource allocation condition in the PaaS layer, execute the quantum computing task by a quantum virtual machine and execute the classical computing task by a classical server.

In some embodiments, the SaaS layer includes: a user programming module, configured to provide the user interface for acquiring the hybrid quantum-classical programming language corresponding to the to-be-executed task.

In some embodiments, the resource management and scheduling module is configured to:
compute a first to-be-allocated resource corresponding to the quantum computing task, and determine, according to the first to-be-allocated resource, a first target classical server from idle classical servers in the IaaS layer, so as to deploy the quantum virtual machine on the first target classical server, and
compute a second to-be-allocated resource corresponding to the classical computing task, and determine, according to the second to-be-allocated resource, a second target classical server from the idle classical servers in the IaaS layer, so as to execute the classical computing task by the second classical server.

In some embodiments, the PaaS layer includes: a quantum virtual machine deployment module, configured to acquire information about the first target classical server determined by the resource management and scheduling module, and deploy the quantum virtual machine on the first target classical server.

In some embodiments, the IaaS layer includes: the quantum virtual machine that is on the first target classical server and configured to execute the quantum computing task; and the second target classical server configured to execute the classical computing task.

In some embodiments, the IaaS layer includes:
a storage device, configured to store data; and
a network device, configured to carry out communication among various devices in the IaaS layer.

In some embodiments, the IaaS layer includes: an infrastructure management module, configured to carry out management, monitoring and operation maintenance on infrastructures in the IaaS layer.

In some embodiments, the SaaS layer includes: a solution providing module, configured to provide a machine vision solution and a reinforcement learning solution.

In a second aspect, the present application provides a hybrid quantum-classical task execution method, applied to the hybrid quantum-classical cloud platform described above, including:
acquiring, by the user interface in the SaaS layer, the hybrid quantum-classical programming language corresponding to the to-be-executed task;
obtaining the quantum computing task and the classical computing task corresponding to the to-be-executed task by executing algorithm compilation and task separation on the hybrid quantum-classical programming language through the PaaS layer, and allocating resources to the quantum computing task and the classical computing task respectively; and
executing, according to the resource allocation condition in the PaaS layer, the quantum computing task by the quantum virtual machine and executing the classical computing task by the classical server through the IaaS layer.

### BRIEF DESCRIPTION OF THE DRAWINGS

In order to more clearly illustrate technical solutions of embodiments of the present disclosure or the related art, the figures that are required to describe the embodiments or the related art will be briefly introduced below. Apparently, the figures that are described below are embodiments of the present disclosure, and those skilled in the art may obtain other figures according to these figures without paying creative work.

FIG. 1 is a schematic structural diagram illustrating a hybrid quantum-classical cloud platform provided by the present disclosure;

FIG. 2 is a schematic structural diagram illustrating a particular hybrid quantum-classical cloud platform provided by the present disclosure;

FIG. 3 is a schematic structural diagram illustrating a particular hybrid quantum-classical cloud platform provided by the present disclosure; and

FIG. 4 is a flow chart of a particular hybrid quantum-classical task execution method provided by the present disclosure;

FIG. 5 is a schematic diagram illustrating an electronic device provided by the present disclosure.

### DETAILED DESCRIPTION

The technical solutions in the embodiments of the present disclosure will be described clearly and completely below in conjunction with the accompanying drawings in the embodiments of the present disclosure. Apparently, the described embodiments are only part of the embodiments of the present disclosure, not all of them. Based on the embodiments in the present disclosure, all other embodiments obtained by those skilled in the art without paying creative work belong to the scope of protection in the present disclosure.

At present, a quantum computing cloud platform is mainly configured to provide online quantum chip or simulation services. However, in the current quantum computing cloud architecture, classical computing needs to be done in a local device or other settings, and then frequent communication with the quantum computing cloud platform is carried out to complete the whole computing. Due to a fact that frequent communication between classical computing clusters and quantum computing clusters needs to be carried out, cross-cluster communication causes a large amount of communication overhead. Therefore, data delay between quantum chips and classical equipment is too large, and even original advantages of the quantum computing are lost. Therefore, the present disclosure provides a hybrid quantum-classical cloud platform, which may reduce the communication overhead and the data delay, improve the task processing efficiency and exert the advantages of the quantum computing.

A cloud platform is a delivery and usage model for IT infrastructure. Computing services based on cloud platforms are referred to as cloud computing. Typically, the cloud platform is configured to store data or run applications and services in a distributed manner. The application and service components of the cloud platform may include nodes such as computing devices, processing units, or virtual machines, physical machines, blades in server racks. The nodes are allocated to run one or more portions of the applications and services. A “node” refers to a conceptual unit in a pool or group in a defined computing resource. Computing resources are provided by physical machines such as servers. Servers can be classified as virtual machines or physical machines that run separate service applications concurrently in a personalized computing environment of supporting resources and/or operating system specific to each service application. Further, each application or service can be divided into jobs so that each functional part can run on a separate (physical or virtual) machine. In a cloud platform, multiple servers can be used to run applications and services to perform data storage operations in a cluster. These servers can perform data operations independently, but are exposed as a single device, which is called as a cluster. Each node can correspond to one or more servers and/or virtual machines in the cluster.

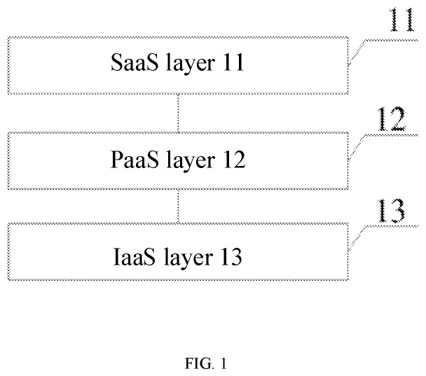

As shown in FIG. 1, an embodiment of the present disclosure provides a hybrid quantum-classical cloud platform including a software-as-a-service (SaaS) layer 11, a Platform as a Service (PaaS) layer 22 and an Infrastructure as a Service (IaaS) layer 13.

The SaaS layer 11 is configured to provide a user interface for acquiring a hybrid quantum-classical programming language corresponding to a to-be-executed task.

The PaaS layer 22 is configured to obtain a quantum computing task and a classical computing task corresponding to the to-be-executed task by executing algorithm compilation and task separation on the hybrid quantum-classical programming language, and allocate resources to the quantum computing task and the classical computing task respectively.

The IaaS layer 13 is configured to, according to a resource allocation condition in the PaaS layer, execute the quantum computing task by a quantum virtual machine and execute the classical computing task by a classical server.

As can be seen, the present disclosure provides the hybrid quantum-classical cloud platform. The cloud platform includes the SaaS layer configured to provide the user interface for acquiring the hybrid quantum-classical programming language corresponding to the to-be-executed task, the PaaS layer configured to obtain the quantum computing task and the classical computing task corresponding to the to-be-executed task by executing algorithm compilation and task separation on the hybrid quantum-classical programming language, and allocate resources to the quantum computing task and the classical computing task respectively, and the IaaS layer configured to, according to the resource allocation condition in the PaaS layer, execute the quantum computing task by the quantum virtual machine and execute the classical computing task by the classical server. According to the present application, the user interface is arranged on the SaaS layer so that users may input the hybrid quantum-classical programming language through the user interface, and a user-unfriendly problem caused by that an existing quantum cloud platform only supports a single mode of quantum programming is solved. Moreover, when the hybrid quantum-classical programming language is compiled in the PaaS layer, the to-be-executed task is divided into the quantum computing task and the classical computing task, and corresponding IaaS layer resources are configured to execute the corresponding tasks. Thus the double computing modes are carried out to realize synchronous and rapid execution, the computing resources are utilized to the maximum extent, and the task processing efficiency is improved. In addition, the quantum virtual machine for quantum computing and the classical virtual machine for classical computing are both at the IaaS layer so that the communication between the quantum virtual machine for quantum computing and the classical virtual machine for classical computing becomes intra-cluster communication, which reduces the time delay of cross-cluster communication, reduces the communication overhead and the data delay, and exerts the advantages of quantum computing.

In a particular implementation process, the SaaS layer is mainly configured to provide an application scene solution for the user, and in particular to provide the user interface for providing user services so that the hybrid quantum-classical programming language corresponding to the to-be-executed task may be obtained through the user interface. In other words, the SaaS layer includes a user programming module configured to provide the user interface for acquiring the hybrid quantum-classical programming language corresponding to the to-be-executed task. The classical programming language may be python, quantum programming may be graphical quantum circuit programming, and a quantum circuit may be embedded into the python to form the hybrid quantum-classical programming language. Therefore, it is very convenient to be used by the user.

In particular, the PaaS layer is mainly an efficient task division and resource scheduling platform. The PaaS layer mainly includes a quantum and classical algorithm compilation module configured to obtain the quantum computing task and the classical computing task corresponding to the to-be-executed task by executing algorithm compilation and task separation on the hybrid quantum-classical programming language, and a resource management and scheduling module configured to allocate resources for the quantum computing task and the classical computing task respectively.

The resource management and scheduling module is configured to: compute a first to-be-allocated resource corresponding to the quantum computing task, determine a first target classical server from idle classical servers in the IaaS layer according to the first to-be-allocated resource, so as to deploy a quantum virtual machine on the first target classical server; compute a second to-be-allocated resource corresponding to the classical computing task, determine a second target classical server from the idle classical servers in the IaaS layer according to the second to-be-allocated resource, so as to execute the classical computing task by the second classical server.

In other words, the resource management and scheduling module will determine how many classical servers are required for deploying the quantum virtual machines according to the quantum computing task, and then determine a corresponding number of first target classical servers from the idle classical servers in the IaaS layer for deploying the quantum virtual machines. Further, the resource management and scheduling module will also determine how many classical servers are required for performing classical computing according to the classical computing task, and then determine a corresponding number of second target classical servers from the idle classical servers in the IaaS layer for executing the classical computing task.

Accordingly, the PaaS layer includes a quantum virtual machine deployment module that is configured to acquire information about the first target classical server determined by the resource management and scheduling module and deploy the quantum virtual machine on the first target classical server. In other words, the PaaS layer further includes the quantum virtual machine deployment module for installing, after the resource management and scheduling module allocates the resources, the quantum virtual machine on the first target classical server requiring the quantum virtual machine.

In addition, the PaaS layer further includes a cloud platform operating system.

In a practical implementation process, the IaaS layer is mainly configured to perform complete infrastructure construction. The IaaS layer includes: the quantum virtual machine that is on the first target classical server and configured to execute the quantum computing task; and the second target classical server configured to execute the classical computing task. The first target classical server and the second target classical server need to be physically separated from each other.

The quantum virtual machine is deployed on a part of classical servers separated according to quantum computing task requirements of a user, and is capable of providing quantum computing services. For the user, whether the task runs on a physical quantum computer or a quantum virtual machine is not perceived. The classical computing task is executed through other parts of classical servers in the IaaS layer. Therefore, the communication between quantum and classical is in a cluster, and the delay is greatly reduced.

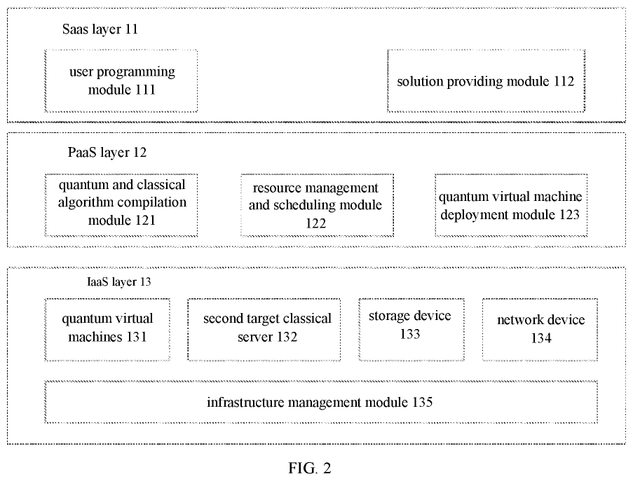

As shown in FIG. 2, an embodiment of the present disclosure provides a particular hybrid quantum-classical cloud platform, including a user programming module 111, a solution providing module 112, a quantum and classical algorithm compilation module 121, a resource management and scheduling module 122, a quantum virtual machine deployment module 123, a quantum virtual machine 131, a second target classical server 132, a storage device 133, a network device 134 and an infrastructure management module 135.

The user programming module 111 is in the SaaS layer 11, and configured to provide the user interface for acquiring the hybrid quantum-classical programming language corresponding to the to-be-executed task.

The solution providing module 112 is in the SaaS layer 11, and configured to provide a machine vision solution and a reinforcement learning solution.

The quantum and classical algorithm compilation module 121 is in the PaaS layer 12, and configured to obtain the quantum computing task and the classical computing task corresponding to the to-be-executed task by executing algorithm compilation and task separation on the hybrid quantum-classical programming language.

The resource management and scheduling module 122 is in the PaaS layer 12, and configured to allocate the resources to the quantum computing task and the classical computing task respectively.

The quantum virtual machine deployment module 123 is in the PaaS layer 12, and configured to: acquire the information about the first target classical server determined by the resource management and scheduling module; and deploy the quantum virtual machine on the first target classical server.

The quantum virtual machine 131 is on the first target classical server in the IaaS layer 13, and configured to execute the quantum computing task.

The second target classical server 132 is in the IaaS layer 13, and configured to execute the classical computing task.

The storage device 133 is in the IaaS layer 13, and configured to store data.

The network device 134 is in the IaaS layer 13, and configured to carry out communication among various devices in the IaaS layer.

The infrastructure management module 135 is in the IaaS layer 13, and configured to carry out management, monitoring and operation maintenance on infrastructures in the IaaS layer.

In the particular implementation process, besides the user programming module 111 configured to provide the user interface for acquiring the hybrid quantum-classical programming language corresponding to the to-be-executed task through the user interface, the SaaS layer further includes a solution providing module 112 configured to provide the machine vision solution and the reinforcement learning solution.

That is to say, the SaaS layer is also capable of providing a solution for part of scenes. Firstly, a machine vision solution with high generalization ability may be provided. Machine vision is one of the core directions of the artificial intelligence (AI) field and is widely applied to object recognition, object detection, pixel-level semantic segmentation and the like. However, the over-fitting phenomenon of a traditional convolutional neural network is serious. The SaaS layer provides a quantum convolutional neural network solution, in which a full-linear quantum (convolutional) neural network is constructed by a quantum rotation gate and a quantum controlled NOT gate and has high generalization performance. The SaaS layer is capable of providing a plurality of quantum convolutional neural network models for object recognition based on a cloud platform. Secondly, a quantum reinforcement learning solution for complex scenes is provided. Classical reinforcement learning has a poor learning effect in a complex scene. On the contrary, the quantum reinforcement learning has a large available environment space and a behavior space due to high quantum parallelism, and the speed for obtaining optimal solution is far higher than the classical reinforcement learning. The SaaS layer is capable of providing a plurality of quantum reinforcement learning solutions for typical scenes.

In practical application, besides the quantum virtual machine 131 that is on the first target classical server and configured to execute the quantum computing task and the second target classical server 132 configured to execute the classical computing task, the IaaS layer further includes the storage device 133 configured to store data, the network device 134 configured to carry out communication between various devices in the IaaS layer, and the infrastructure management module 135 configured to carry out management, monitoring and operation maintenance on infrastructures in the IaaS layer.

In other words, the IaaS layer further includes the storage device 133 configured to store data, the network device 134 configured to carry out communication between various devices in the IaaS layer, and the infrastructure management module 135 configured to carry out management, monitoring and operation maintenance on basic settings in the IaaS layer.

The infrastructure management module 135 is configured to: monitor the occupation and remaining conditions of resources in real time, and feed back the occupation and remaining conditions to the PaaS layer for task evaluation; perform fault detection and automatic repair of hardware, and issue an early warning when automatic repair fails, so that operation and maintenance personnel may carry out manual repair.

After the quantum computing task and the classical computing task are finished, occupied resources may be released, the released resources are considered as idle resources and may be called for subsequent tasks.

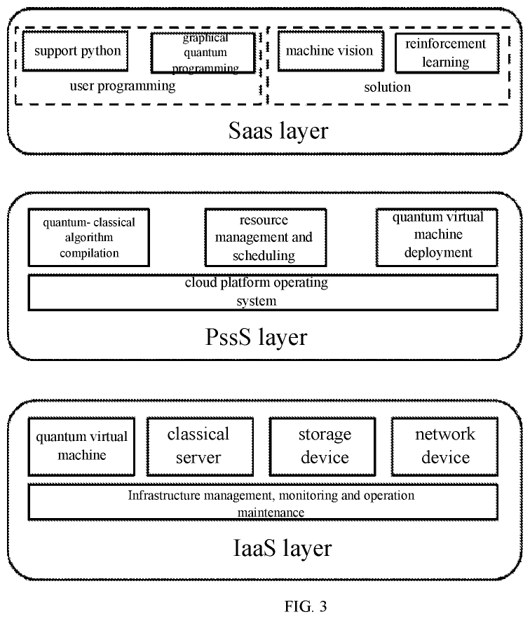

FIG. 3 is a schematic structural diagram illustrating the hybrid quantum-classical cloud platform. The hybrid quantum-classical cloud platform includes the SaaS layer, the PaaS layer and the IaaS layer. The SaaS layer includes the user programming module configured to provide the user interface for acquiring the hybrid quantum-classical programming language corresponding to the to-be-executed task. The classical programming language supports python; quantum programming may be graphical quantum circuit programming; and the quantum circuit may be embedded into the python to form the hybrid quantum-classical programming language, thus it is very convenient to be used by the user. The SaaS layer further includes the solution providing module configured to provide the machine vision solution and the reinforcement learning solution. The PaaS layer includes: the quantum and classical algorithm compilation module configured to obtain the quantum computing task and the classical computing task corresponding to the to-be-executed task by executing algorithm compilation and task separation on the hybrid quantum-classical programming language; the resource management and scheduling module configured to allocate the resources to the quantum computing task and the classical computing task, and the quantum virtual machine deployment module configured to acquire the information about the first target classical server determined by the resource management and scheduling module and deploy the quantum virtual machine on the first target classical server. The PaaS layer further includes the cloud platform operating system. The IaaS layer includes classical servers, and the classical servers include the first target classical server configured to deploy the quantum virtual machine and the second target classical server configured to execute the classical computing task. The IaaS layer further includes the quantum virtual machine on the first target classical server and configured to execute the quantum computing task. The IaaS layer further includes the storage device configured to store data, the network device configured to carry out communication among various devices in the IaaS layer, and the infrastructure management module (namely, infrastructure management, monitoring and operation maintenance in the figure) configured to carry out management, monitoring and operation maintenance on the infrastructures in the IaaS layer.

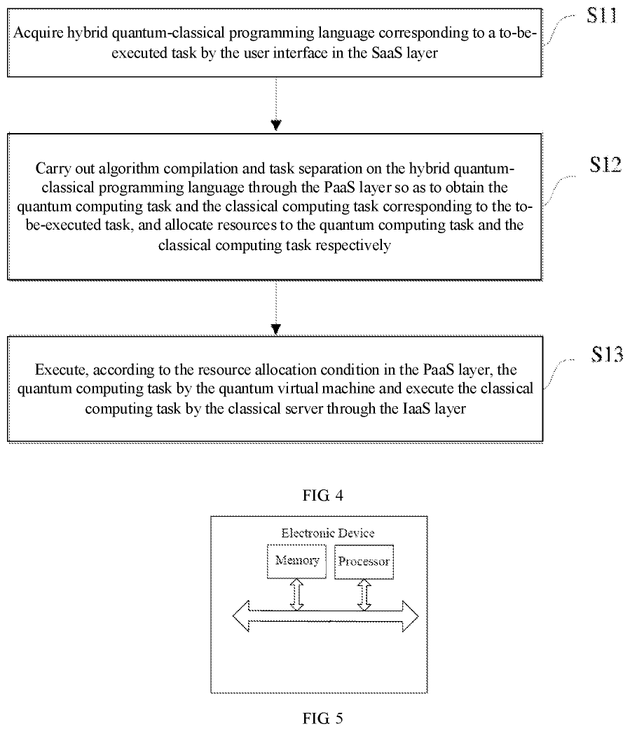

As shown in FIG. 4, an embodiment of the present disclosure provides a particular hybrid quantum-classical task execution method, applied to the abovementioned hybrid quantum-classical cloud platform. The method includes steps described below.

At step S11, the hybrid quantum-classical programming language corresponding to the to-be-executed task is acquired by the user interface in the SaaS layer.

Firstly, the hybrid quantum-classical programming language corresponding to the to-be-executed task needs to be acquired through the user interface in the SaaS layer. The classical programming language supported by the user interface may be python, the quantum programming may be graphical quantum circuit programming, and the quantum circuit may be embedded into the python to form the hybrid quantum-classical programming language, so that it is very convenient to be used by the user.

At step S12, the quantum computing task and the classical computing task corresponding to the to-be-executed task are obtained by executing algorithm compilation and task separation on the hybrid quantum-classical programming language through the PaaS layer, and resources are allocated to the quantum computing task and the classical computing task respectively.

After the hybrid quantum-classical programming language is acquired, algorithm compilation and task separation are executed on the hybrid quantum-classical programming language through the PaaS layer, the to-be-executed task is divided into the quantum computing task and the classical computing task, and resources are allocated to the quantum computing task and the classical computing task respectively.

That is, after the to-be-executed task is divided into the quantum computing task and the classical computing task, how many classical servers are needed for deploying the quantum virtual machine may be determined according to the quantum computing task, and then a corresponding number of first target classical servers may be determined from idle classical servers in the IaaS layer for deploying the quantum virtual machines. How many classical servers are needed for performing classical computing may be determined according to the classical computing task, and then a corresponding number of second target classical servers may be determined from the idle classical servers in the IaaS layer for executing the classical computing.

At step S13, in the IaaS layer, according to the resource allocation condition in the PaaS layer, the quantum computing task is executed by the quantum virtual machine and the classical computing task is executed by the classical server.

After resource allocation is carried out, the IaaS layer is configured to execute, according to the resource allocation condition in the PaaS layer, the quantum computing task by the quantum virtual machine and execute the classical computing task by the classical server. That is, the quantum computing task is executed through the quantum virtual machine deployed on the first target classical server in the IaaS layer, and the classical computing task is executed through the second target classical server in the IaaS layer. Therefore, the quantum computing task and the classical computing task may be synchronously processed, double computing modes are carried out to realize synchronous and rapid execution, thus the computing resources are utilized to the maximum extent, and the task processing efficiency is improved; and the communication between quantum computing and classical computing is the communication in a cluster in the IaaS layer, so that the communication overhead and the data delay are reduced.

After the quantum computing task and the classical computing task corresponding to the to-be-executed task are finished, occupied resources may be released, and the released resources are considered as idle resources and may be called for subsequent tasks.

In practical application, the SaaS layer is also capable of providing a solution for part of scenes. Firstly, the machine vision solution with high generalization ability may be provided. Machine vision is one of the core directions of the AI field and is widely applied to object recognition, object detection, pixel-level semantic segmentation and the like. However, the over-fitting phenomenon of the traditional convolutional neural network is serious. The SaaS layer provides a quantum convolutional neural network solution, in which a full-linear quantum (convolutional) neural network is constructed by a quantum rotation gate and a quantum controlled NOT gate and has high generalization performance. The SaaS layer is capable of providing a plurality of quantum convolutional neural network models for object recognition based on a cloud platform. Secondly, a quantum reinforcement learning solution for complex scenes is provided. Classical reinforcement learning has a poor learning effect in a complex scene. On the contrary, the quantum reinforcement learning has a large available environment space and a behavior space due to high quantum parallelism, and the speed for obtaining optimal solution is far higher than the classical reinforcement learning. The SaaS layer is capable of providing a plurality of quantum reinforcement learning solutions for typical scenes.

Therefore, the user may train the quantum convolutional neural network through the machine vision solution and the reinforcement learning solution provided by the SaaS layer, and the trained quantum convolutional neural network may be configured to carry out object recognition, object detection, pixel-level semantic segmentation and the like.

In addition, other processing operations may also be carried out in the SaaS layer, the PaaS layer and the IaaS layer, and the content disclosed in the embodiments may be referred to for details, and unnecessary description is not carried out any more.

As shown in FIG. 5, an embodiment of the present disclosure provides an electronic device including a processor and a memory. The memory is configured to store a computer program, and the processor is configured to call the computer program stored in the memory and run the computer program to implement the hybrid quantum-classical task execution method described above.

Various embodiments described in the description are described in a progressive manner, each embodiment focuses on the difference from other embodiments, and the same or similar parts of each embodiment can be referred to each other. The device disclosed in the embodiment corresponds to the method disclosed in the embodiment, thus the description thereof is relatively simple, and for the related information, please refer to the description of the method.

The steps of the methods or algorithms described in connection with the embodiments disclosed herein may be directly implemented by hardware, software modules executed by a processor, or a combination of both. Software modules can be placed in random access memory (RAM), internal memory, read-only memory (ROM), electrically programmable ROM, electrically erasable programmable ROM, registers, hard disk, removable disk, CD-ROM, or any other storage medium known in the technical field.

Finally, it should be noted that, in the present disclosure, relationship terms such as first and second are only used to distinguish one entity or operation from another entity or operation, and do not necessarily require or imply any such actual relationship or sequence existsbetween these entities or operations. Moreover, the terms “comprising”, “including” or any other variation thereof are intended to encompass non-exclusive inclusion such that a process, method, article or device including a list of elements includes not only those elements, but also other not expressly listed elements, or also include elements inherent to such a process, method, article or apparatus. Without further limitation, an element qualified by the phrase “comprising a . . . ” does not preclude the presence of additional identical elements in a process, method, article or apparatus that includes the element.

The above is a detailed introduction of a hybrid quantum-classical cloud platform and a hybrid quantum-classical task execution method provided by this application. In the description, specific examples are used to illustrate the principle and implementation of this application. The description of the above embodiments is only used to help understand the method of the present application and its core idea. Meanwhile, for those skilled in the art, according to the idea of the present application, there will be changes in the specific implementation and application scope. In summary, the contents of the description should not be understood as limiting the application.

1. A hybrid quantum-classical cloud platform, comprising:
a software-as-a-service (SaaS) layer, configured to provide a user interface for acquiring a hybrid quantum-classical programming language corresponding to a to-be-executed task;
a platform as a service (PaaS) layer, configured to obtain a quantum computing task and a classical computing task corresponding to the to-be-executed task by executing algorithm compilation and task separation on the hybrid quantum-classical programming language, and allocate resources to the quantum computing task and the classical computing task respectively; and
an infrastructure as a service (IaaS) layer, configured to, according to a resource allocation condition in the PaaS layer, execute the quantum computing task by a quantum virtual machine and execute the classical computing task by a classical server.

2. The hybrid quantum-classical cloud platform according to claim 1, wherein the SaaS layer comprises:
a user programming module, configured to provide the user interface for acquiring the hybrid quantum-classical programming language corresponding to the to-be-executed task.

3. The hybrid quantum-classical cloud platform according to claim 1, wherein the PaaS layer comprises:
a quantum and classical algorithm compilation module, configured to obtain the quantum computing task and the classical computing task corresponding to the to-be-executed task by executing algorithm compilation and task separation on the hybrid quantum-classical programming language; and
a resource management and scheduling module, configured to allocate resources for the quantum computing task and the classical computing task respectively.

4. The hybrid quantum-classical cloud platform according to claim 3, wherein the resource management and scheduling module is configured to:
compute a first to-be-allocated resource corresponding to the quantum computing task, and determine, according to the first to-be-allocated resource, a first target classical server from idle classical servers in the IaaS layer, so as to deploy the quantum virtual machine on the first target classical server, and
compute a second to-be-allocated resource corresponding to the classical computing task, and determine, according to the second to-be-allocated resource, a second target classical server from the idle classical servers in the IaaS layer, so as to execute the classical computing task by the second classical server.

5. The hybrid quantum-classical cloud platform according to claim 4, wherein the PaaS layer comprises:
a quantum virtual machine deployment module, configured to acquire information about the first target classical server determined by the resource management and scheduling module, and deploy the quantum virtual machine on the first target classical server.

6. The hybrid quantum-classical cloud platform according to claim 4, wherein the IaaS layer comprises:
the quantum virtual machine that is on the first target classical server and configured to execute the quantum computing task; and
the second target classical server configured to execute the classical computing task.

7. The hybrid quantum-classical cloud platform according to claim 1, wherein the IaaS layer comprises:
a storage device, configured to store data; and
a network device, configured to carry out communication among various devices in the IaaS layer.

8. The hybrid quantum-classical cloud platform according to claim 1, wherein the IaaS layer comprises:
an infrastructure management module, configured to carry out management, monitoring and operation maintenance on infrastructures in the IaaS layer.

9. The hybrid quantum-classical cloud platform according to claim 1, wherein the SaaS layer comprises:
a solution providing module, configured to provide a machine vision solution and a reinforcement learning solution.

10. A hybrid quantum-classical task execution method, applied to a hybrid quantum-classical cloud platform, comprising: a software-as-a-service (SaaS) layer, configured to provide a user interface for acquiring a hybrid quantum-classical programming language corresponding to a to-be-executed task; a platform as a service (PaaS) layer configured to obtain a quantum computing task and a classical computing task corresponding to the to-be-executed task by executing algorithm compilation and task separation on the hybrid quantum-classical programming language, and allocate resources to the quantum computing task and the classical computing task respectively; and an infrastructure as a service (IaaS) layer configured to, according to a resource allocation condition in the PaaS layer, execute the quantum computing task by a quantum virtual machine and execute the classical computing task by a classical server;
wherein the method comprises steps of:
acquiring, by the user interface in the SaaS layer, the hybrid quantum-classical programming language corresponding to the to-be-executed task;
obtaining the quantum computing task and the classical computing task corresponding to the to-be-executed task by executing algorithm compilation and task separation on the hybrid quantum-classical programming language through the PaaS layer, and allocating resources to the quantum computing task and the classical computing task respectively; and
through the IaaS layer and according to the resource allocation condition in the PaaS layer, executing the quantum computing task by the quantum virtual machine and executing the classical computing task by the classical server.

11. The hybrid quantum-classical cloud platform according to claim 1, wherein the hybrid quantum-classical programming language is formed by embedding quantum programming into a classical programming language.

12. The hybrid quantum-classical cloud platform according to claim 11, wherein the classical programming language is python, the quantum programming is graphical quantum circuit programming, and the quantum circuit is embedded into the python.

13. The hybrid quantum-classical cloud platform according to claim 4, wherein the resource management and scheduling module is configured to determine how many classical servers are required for deploying the quantum virtual machine according to the quantum computing task, and determine a corresponding number of first target classical servers from the idle classical servers in the IaaS layer for deploying the quantum virtual machine.

14. The hybrid quantum-classical cloud platform according to claim 4, wherein the resource management and scheduling module is configured to determine how many classical servers are required for performing classical computing according to the classical computing task, and determine a corresponding number of second target classical servers from the idle classical servers in the IaaS layer for executing the classical computing task.

15. The hybrid quantum-classical cloud platform according to claim 3, wherein the PaaS layer further comprises a cloud platform operating system.

16. The hybrid quantum-classical cloud platform according to claim 4, wherein the first target classical server and the second target classical server are physically separated from each other.

17. The hybrid quantum-classical cloud platform according to claim 8, wherein the infrastructure management module is configured to monitor occupation and remaining conditions of resources in real time.

18. The hybrid quantum-classical cloud platform according to claim 9, wherein the solution providing module is configured to provide a quantum convolutional neural network solution.

19. The hybrid quantum-classical task execution method according claim 10, further comprising:
releasing resources occupied after the quantum computing task and the classical computing task are finished.

20. An electronic device, comprising: a processor and a memory, wherein the memory is configured to store a computer program, and the processor is configured to call the computer program stored in the memory and run the computer program to:
provide a user interface for acquiring a hybrid quantum-classical programming language corresponding to a to-be-executed task;
obtain a quantum computing task and a classical computing task corresponding to the to-be-executed task by executing algorithm compilation and task separation on the hybrid quantum-classical programming language, and allocate resources to the quantum computing task and the classical computing task respectively; and
execute, according to a resource allocation condition, the quantum computing task by a quantum virtual machine and execute the classical computing task by a classical server.
